(19) United States
(12) Patent Application Publication
(10) Pub. No.: US 2003/0204735 A1
(43) Pub. Date: Oct. 30, 2003

(54) Storage medium

(76) Inventor: Werner Schnitzmeier, Kongisbrunn (DE)

Correspondence Address: LERNER AND GREENBERG, P.A., POST OFFICE BOX 2480, HOLLYWOOD, FL, 33022-2480, US

(21) Appl. No.: 10/442,742

(22) Filed: May 21, 2003

Related U.S. Application Data
(63) Continuation of application No. PCT/DE01/04349, filed on Nov. 20, 2001.

(30) Foreign Application Priority Data
Nov. 21, 2000 (DE) 100 57 697.4

(51) Int. Cl. H04L 9/00

(52) U.S. Cl. 713/186

(57) ABSTRACT

A storage medium has a storage unit and an authenticating unit with a fingerprint sensor. Access to the storage medium is accomplished by way of a USB interface. If a read and/or write access to the contents of the storage unit is blocked, the block can be lifted only by the authentication of a user by the fingerprint sensor.

### CROSS-REFERENCE TO RELATED APPLICATION

This application is a continuation of copending International Application No. PCT/DE01/04349, filed Nov. 20, 2001, which designated the United States and was not published in English.

### BACKGROUND OF THE INVENTION

### FIELD OF THE INVENTION

The invention relates to a storage medium, particularly a storage medium that is suitable for mobile uses.

A large number of mobile storage media are known. Diskettes are customary for small amounts of data. For larger amounts of data, what are known as ZIP data carriers (manufactured by Iomega) or replaceable disks are frequently used. Flash memories are also in use. Besides problems like small storage capacity (diskettes) or the need for a special drive (ZIP data carriers), there is frequently inadequate protection against unauthorized access. While it is possible to protect these storage media with a password, the protection can usually be overridden with relatively little effort.

### SUMMARY OF THE INVENTION

It is accordingly an object of the invention to provide a storage medium that overcomes the above-mentioned disadvantages of the prior art devices of this general type, which offers improved protection against unauthorized access.

The object is achieved by a storage medium with a storage unit, a USB interface for accessing the contents of the storage unit, and an authentication unit with a fingerprint sensor for authenticating a user. Whereby, if the read and/or write access to the memory contents is blocked, the block can be lifted by the authentication of a user using the fingerprint sensor.

The object is additionally achieved by a storage medium with a storage unit, a USB interface for accessing the contents of the memory unit, and an authentication unit with a fingerprint sensor for authenticating a user. Whereby the data can be filed in the storage unit in encrypted form, and an authentication of the user is performed by the fingerprint sensor and is required for decryption.

Data that are stored in the inventive storage medium can thus be protected in two ways. First, it is possible simply to prevent the read and/or write access until an authorized user is authenticated. Second, it is possible to encrypt the data and to permit decryption only upon the authentication of an authorized user. Both protection concepts can be combined in order to achieve a particularly good protection.

In case of the former, the blocked access is merely released. It is thus no longer possible to get to the stored data by the regular course. However, it is still possible to gain unauthorized knowledge of the stored data by intervening in the storage medium itself. In the latter case, this too is prevented, because the data themselves are encrypted. But the data must be encrypted in both read and write operations, which slows down the access speed.

The development of the interface according to the USB standard is particularly advantageous. This makes it possible to connect the storage medium to, and disconnect it from, a computer system while the computer system is running. Given the utilization of a suitable operating system, the storage medium is then automatically detected and is available as an additional drive, for example.

During the identification of the storage medium, the access rights are automatically interrogated. After the authentication of the user upon placement of a finger on the fingerprint sensor, access to the contents of the storage medium can be accomplished.

Other features which are considered as characteristic for the invention are set forth in the appended claims.

Although the invention is illustrated and described herein as embodied in a storage medium, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of a structure of a storage medium according to the invention; and

FIG. 2 is a perspective view of the storage medium.

### DESCRIPTION OF THE PREFERRED EMBODIMENTS

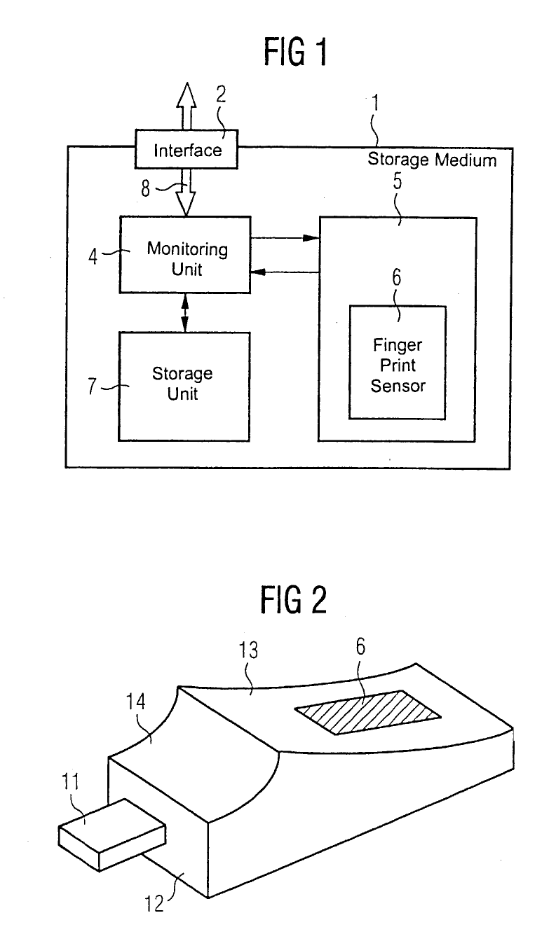

Referring now to the figures of the drawing in detail and first, particularly, to FIG. 1 thereof, there is shown a block circuit diagram of an inventive storage medium 1. With a universal serial bus (USB) interface 2, the storage medium is connected to any other device with a USB interface. Accessing of the storage medium 1 proceeds from there. For instance, assume that data are to be read from the storage medium. A read request is first conducted to an access monitoring unit 4. If access to the storage unit was already granted in an earlier read or write operation, a storage unit 7 can be immediately accessed.

But if this is the first access, then access to the memory contents is denied until an authentication unit 5 with a fingerprint sensor 6 has determined whether authorization exists. The access monitoring unit 4 is connected to the authentication unit 5 to that end. The user places his finger on the fingerprint sensor 6, so that the fingerprint can be read. The authentication unit 5 then analyzes the fingerprint and identifies characteristic lines, known as minutiae. Twenty to thirty minutiae usually suffice to guarantee a reliable recognition. The minutiae are compared to user data that are stored in a memory of the authentication unit 5. If the test indicates that the user is authorized to access the storage medium, a signal indicating this is sent back to the access monitoring unit 4.

In order to achieve an optimally small construction, it is possible to utilize a strip sensor instead of a fingerprint sensor 6 that can read the whole fingerprint. In this case, the finger would not be placed on the strip sensor, but rather moved over it.

Once access is granted by the access monitoring unit 4, the contents can be arbitrarily accessed by way of the USB interface 2. Furthermore, different access rules can be provided for different users, for instance only a read access or a write access, or access to particular memory regions only.

When the storage medium 1 is constructed such that the data are stored in the memory unit 7 in encrypted form, the access monitoring unit 4 also takes over the functions of encryption and decryption. The access monitoring unit 4 is represented as a separate block in FIG. 1. It can, of course, also be realized as part of the authentication unit 5.

In FIG. 2, the storage medium whose function was described in connection with FIG. 1 is represented as a device. The device is substantially square. A plug 11 of the USB interface 2 is represented at a face 12. At a lateral surface 13, the fingerprint sensor 6 is disposed. A bevel is provided at the plug-end of the lateral surface 13 as a grip surface 14. That way, the storage medium can be easily removed from a USB counter plug.

In order to use the inventive storage medium 1, the medium is connected to the USB interface of any device. If this is a computer with an operating system that supports the USB standard, the storage medium 1 is automatically recognized as an additional drive. Access is then achieved like access to a normal disk drive or diskette.

I claim:

1. A storage medium, comprising:
a storage unit;
a USB interface for accessing contents of said storage unit, said USB interface coupled to said storage unit; and
an authentication unit with a fingerprint sensor for authenticating a user and coupled to said USB interface, if a read and/or write access to said storage unit is blocked, the block can be lifted by authentication of the user by said fingerprint sensor.

2. A storage medium, comprising:
a storage unit;
a USB interface for accessing contents of said storage unit, said USB interface coupled to said storage unit; and
an authentication unit with a fingerprint sensor for authenticating a user and couple to said USB interface, if data are stored in said storage unit in encrypted form, an authentication of the user is required for decryption.

3. The storage medium according to claim 2, wherein if access is blocked, the block can be lifted by the authentication of the user by said fingerprint sensor.
